(19) United States
(12) Patent Application Publication
(10) Pub. No.: US 2026/0079058 A1
(43) Pub. Date: Mar. 19, 2026

(54) TACTILE SENSING SYSTEM WITH EXPANDED SENSING COVERAGE

(71) Applicant: Sanctuary Cognitive Systems Corporation, Vancouver (CA)

(72) Inventors: Jason L. Vasquez, Chico, CA (US); Jeremy A. Fishel, Chico, CA (US); William Cortez, Chico, CA (US); Ethan A. Lodermeier, Vancouver (CA); Connor Richard Shannon, Vancouver (CA)

(21) Appl. No.: 19/329,447

(22) Filed: Sep. 15, 2025

Related U.S. Application Data
(60) Provisional application No. 63/695,031, filed on Sep. 16, 2024.

(51) Int. Cl. G01L 5/00; G01L 1/22

(52) U.S. Cl. CPC G01L 5/0038; G01L 1/2218; G01L 5/0061

(57) ABSTRACT

A tactile sensing system includes a compliant tactile sensor having a first compliant member and a sensing circuit arranged to detect and measure a response of the first compliant member to contact forces applied to the first compliant member. The tactile sensing system includes a sensor contact disposed adjacent to the first compliant member to mechanically engage and apply a first contact force to the first compliant member in response to a second contact force applied to the sensor contact.

### CROSS-REFERENCE TO RELATED APPLICATIONS

This application claims the benefit of U.S. Provisional Application No. 63/695,031 filed Sep. 16, 2024, the content of which is incorporated herein by reference.

### FIELD

The field generally relates to robotics and particularly to tactile sensing in robotics.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

### SUMMARY

In a representative example, a tactile sensing system includes a compliant tactile sensor having a first compliant member and a sensing circuit arranged to detect and measure a response of the first compliant member to contact forces applied to the first compliant member. The tactile sensing system includes a sensor contact disposed adjacent to the first compliant member to mechanically engage the first compliant member in response to a contact force applied to the sensor contact and transmit the contact force to the first compliant member.

In a representative example, a tactile sensing system includes a compliant tactile sensor having a first cell containing a first fluid medium, a first elastic skin forming at least a portion of a boundary of the first cell, and a pressure sensing circuit communicatively coupled to the first cell. Contact forces applied to the first elastic skin deform the elastic skin and produce measurable changes in fluid pressure inside the first cell. The tactile sensing system includes a compliant sensor contact having a second cell containing a second fluid medium and a second elastic skin forming at least a portion of a boundary of the second cell. The second elastic skin has a distal portion disposed adjacent to a proximal portion of the first elastic skin. A contact force applied to the second elastic skin produces a measurable change in fluid pressure inside the second cell that is transmitted to the first cell through deformable engagement between the distal portion of the second elastic skin and the proximal portion of the first elastic skin.

In a representative example, a tactile sensing system includes a compliant tactile sensor having a cell containing a fluid medium, an elastic skin forming at least a portion of a boundary of the cell, and a pressure sensing circuit communicatively coupled to the cell. Contact forces applied to the elastic skin deform the elastic skin and produce measurable changes in fluid pressure inside the cell. The tactile sensing system includes a rocker sensor contact having a rocker body disposed adjacent to and rotatably mounted relative to the compliant tactile sensor. A contact force applied to the rocker body causes the rocker body to rotate into engagement with the elastic skin and transmit the contact force to the elastic skin.

### BRIEF DESCRIPTION OF THE DRAWINGS

FIG. 1 is a cross-sectional view of a compliant tactile sensor.

FIG. 2 is a cross-sectional view of a compliant sensor contact.

FIG. 3A is a cross-sectional view of a tactile sensing system including the compliant tactile sensor of FIG. 1 and the compliant sensor contact of FIG. 2.

FIG. 3B illustrates transmission of contact force from the compliant sensor contact to the compliant tactile sensor of the tactile sensing system of FIG. 3A.

FIG. 4A is a cross-sectional view of a tactile sensing system including the compliant tactile sensor of FIG. 1 and a rocker sensor contact.

FIG. 4B illustrates transmission of contact force from the rocket sensor contact to the compliant tactile sensor of the tactile sensing system of FIG. 4A.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or linked and does not exclude the presence of intermediate elements between the coupled elements absent specific contrary language. The term “plurality” or “plural” when used together with an element means two or more of the element. Directions and other relative references (e.g., inner and outer, upper and lower, above and below, left and right, proximal and distal, and ventral and dorsal) may be used to facilitate discussion of the drawings and principles but are not intended to be limiting.

The headings and Abstract are provided for convenience only and are not intended, and should not be construed, to interpret the scope or meaning of the disclosed technology.

### EXAMPLE I

### Overview

Dexterous manipulation of a robotic hand can be enhanced by expanding the sensing regions on the robotic hand. However, it is challenging to route electrical wires and design custom tactile sensors for every region of the robotic hand. It is particularly challenging to apply tactile sensors over joints in the robotic hand, where, in the case of convex joints, collisions are highly probable. Other parts of the robotic body that may benefit from tactile sensing are subject to the same challenges. Developing active sensors over all these regions is not only challenging, but the high degree of information from the active sensors can be strenuous to process and use in training machine learning policies. In addition, robotic systems are densely populated with components, often leaving no room for additional electronics and tactile sensors.

Described herein are tactile sensing systems that may be used to expand sensing regions on a robotic body. The tactile sensing systems include a compliant tactile sensor and a sensor contact that mechanically engages the compliant tactile sensor to transmit a contact force applied to the sensor contact to the compliant tactile sensor for detection and measurement by the compliant tactile sensor.

Since the compliant tactile sensor can detect and measure the contact force applied to the sensor contact, there is no need to incorporate active components in the sensor contact, which would significantly simplify integration of the tactile sensing system in a robotic system. For example, only the compliant tactile sensor having the active components would require power and communication wiring.

Since only the compliant tactile sensor needs to generate data, the overall amount of data to be processed for the tactile sensing system is reduced for the coverage area of the system compared to if multiple active sensors were used for the same coverage area and each active sensor is actively generating data. While the overall amount of data for the tactile sensing system is reduced, the data is still representative of sensing in the coverage area. The reduced data can have the benefit of reduced complexity of data processing and increased use of the data in training machine learning policies.

The compliant tactile sensor and the sensor contact can have compliant parts that cushion the effect of contact or collision on the robot surfaces to which the tactile sensing system is attached. The sensor contact can be used with a pre-existing tactile sensor to enable a larger and integrated sensing region without the need to redesign the pre-existing tactile sensor, which can lead to a more rapid prototyping of compliant and sensitive regions over the robot.

The tactile sensing system can have a lower cost in terms of component costs, engineering time, and manufacturing costs compared to an array of tactile sensors with the same sensing coverage as the tactile sensing system. The relatively lower cost of the tactile sensing system can allow the tactile sensing system to be consumable and used to cover larger robot surfaces that are subject to wear and tear.

### EXAMPLE II

### Compliant Tactile Sensor

The compliant tactile sensor used in tactile sensing systems described herein can be any tactile sensor with a compliant part that deforms responsively to contact forces.

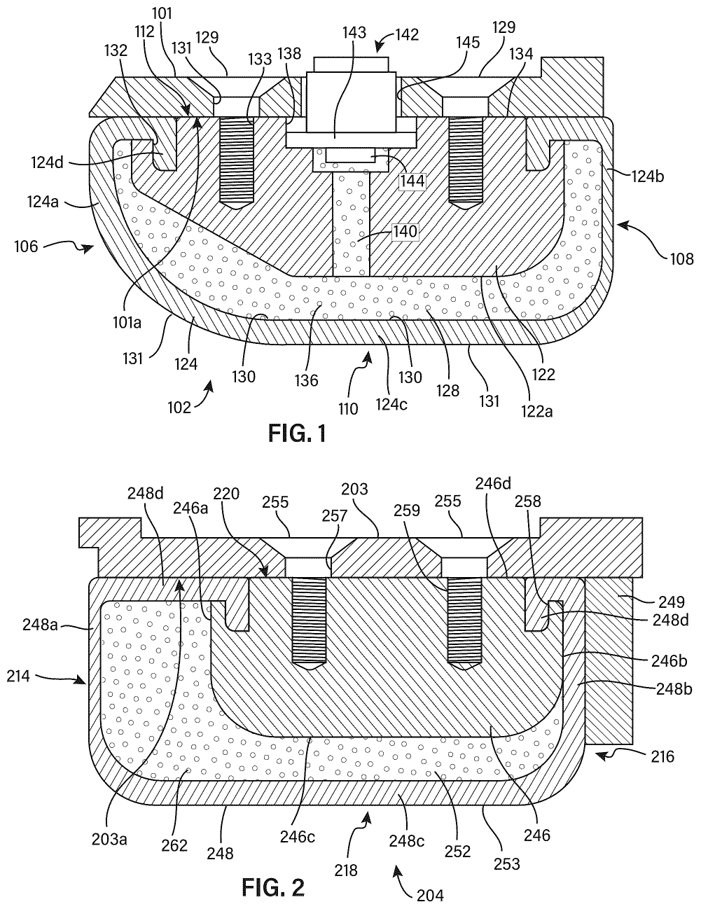

FIG. 1 illustrates an example compliant tactile sensor 102 that may be used in tactile sensing systems described herein. The illustrated compliant tactile sensor 102 is a fluid-based device. However, the tactile sensing systems described herein are not limited to the particular fluid-based compliant tactile sensor shown in FIG. 1. In the illustrated example, the compliant tactile sensor 102 is shaped for attachment to a distal phalanx of a robotic finger (e.g., can function as a tip of a robotic finger). In general, the compliant tactile sensor 102 may be suitably shaped to conform to any desired surface of a robot.

The compliant tactile sensor 102 has a distal side 106, a proximal side 108 generally opposite to and spaced from the distal side 106, a ventral side 110, and a dorsal side 112 generally opposite and spaced from the ventral side 110. The distal side 106, the proximal side 108, and the ventral side 110 have compliant portions that are deformable by applied contact force. The dorsal side 112 of the compliant tactile sensor 102 may be attached to a surface of interest (e.g., a surface 101a of a support structure 101). The surface of interest may be, for example, a surface of a robot part (e.g., a surface of a robotic finger).

The compliant tactile sensor 102 includes a core 122, an elastic skin 124 disposed around a surface portion 122a of the core 122, and a cell 128 occupying a space between the surface portion 122a of the core 122 and the elastic skin 124. The cell 128 contains a fluid medium 136. In some examples, the fluid medium 136 can be a compressible fluid (e.g., a gaseous medium such as air, which can be ambient or compressed). In other examples, there may be multiple cells in the space between the core 122 and elastic skin 124 (the cells may be isolated from each other, or fluid communication between the cells may be permissible).

The elastic skin 124 forms a compliant member of the compliant tactile sensor 102 that is deformable in response to applied contact force. The elastic skin 124 can be formed from an elastomer (e.g., silicone) or other resilient material. In some examples, the material of the elastic skin 124 is substantially impermeable to the fluid medium 136 in the cell 128. In some examples, either or both of the outer surface 131 and the inner surface 130 of the elastic skin 124 may include textures (not shown). For example, textures on the outer surface 131 may facilitate gripping of an external surface with the elastic skin 124, while textures on the inner surface 130 may serve to expand a dynamic range of the tactile sensor (as described, for example, in U.S. Provisional Application No. 63/663069 filed June 22, 2024).

The core 122 is relatively rigid compared to the elastic skin 124 (e.g., the elastic skin 124 can be pushed against the core 122 without deforming the core 122, or the core 122 can be sturdy enough to support a pressure sensing circuit). In some examples, the core 122 may be constructed (e.g., machined or molded) from hard plastic or metal. The elastic skin 124 can be attached to the core 122 to encapsulate the cell 128 between the elastic skin 124 and the core 122. For example, the elastic skin 124 may be molded onto the core 122 or may be formed separately and attached to the core 122. In some examples, the elastic skin 124 can be attached to the core 122 by retaining an edge portion 124d of the elastic skin 124 in an annular groove 132 formed in a dorsal surface 134 of the core 122 (the dorsal surface 134 is part of the dorsal side 112 of the compliant tactile sensor 102).

In some examples, the surface 101a of the support structure 101 can play a role in assembly of the compliant tactile sensor 102. For example, the surface 101a can extend over the dorsal surface 134 of the core 122 and the edge portion 124d and can be attached to the core 122 using, for example, threaded fasteners 129 that extend through holes 131 in the support structure 101 and threadedly engage corresponding holes 133 in the core 122. The force applied to the edge portion 124d by forming the threaded connections may enable the edge portion 124d to form a gasket that seals the interface between the elastic skin 124 and the core 122 at the annular groove 132. In other examples, alternative methods of sealing the interface between the elastic skin 124 and the core 122 may be used (e.g., sealing with O-rings or diaphragms).

The compliant tactile sensor 102 includes a pressure sensing circuit 142 arranged to measure fluid pressure in the cell 128. The pressure sensing circuit 142 includes a circuit board 143 and a pressure transducer 144 attached to the circuit board 143. In some examples, the core 102 includes an inner chamber 138 and a channel 140 connecting the inner chamber 138 to the cell 128. In some examples, the pressure transducer 144 is mounted in the inner chamber 138 and exposed to the fluid pressure in the cell 128 through the channel 140. The circuit board 143 may be disposed on the side of the pressure transducer 144 that is farther away from the channel 140 and may extend through an opening 145 in the support structure 101 for connection of the circuit board 143 to other systems (e.g., a robot controller or power system or communication system).

The pressure transducer 144 includes a pressure-sensitive element that can measure fluid pressure and convert the measurements into an electric output signal. The pressure transducer 144 can be, for example, a strain-gauge pressure transducer. The circuit board 143 includes electrical circuitry that can communicate with the pressure transducer 144 (e.g., receive electrical output signals from the pressure transducer 144 and provide electrical power to the pressure transducer 144). In some examples, the pressure sensing circuit 142 may further include a temperature sensor (not shown) whose output can be used in interpreting the pressure measurements. Alternatively, temperature readings may be provided by a temperature sensor that is not associated with the pressure sensing circuit 142.

The elastic skin 124 has a distal portion 124a corresponding to the distal side 106 of the compliant tactile sensor 102, a proximal portion 124b corresponding to the proximal side 108 of the compliant tactile sensor 102, and a ventral portion 124c corresponding to the ventral side 110 of the compliant tactile sensor 102. When a contact force is applied to the elastic skin 124 at any of these portions (e.g., by touching or colliding with the portions), the elastic skin 124 can deform. The fluid pressure in the cell 128 is responsive to deformation of the elastic skin 124 (e.g., the fluid pressure in the cell 128 may increase proportionally to the applied contact force on the elastic skin 124). The pressure sensing circuit 142 detects and measures changes in the fluid pressure. The elastic skin 124 can be relatively thin at the proximal portion 124b (e.g., the proximal portion 124b can be thinner than the distal portion 124a and the ventral portion 124c) to encourage deformation of the proximal portion 124b when force is applied to the proximal portion 124b by a neighboring sensor contact.

In some examples, the core 122 may be provided with an inflation port (not shown) that allows the cell 128 to be refillable with the fluid medium 136. The inflation port may be a passage formed in the core 122 and connected to the cell 138. The passage may be accessible from outside the compliant tactile sensor 102 (e.g., have an opening at the dorsal side of the core 122). In some examples, a miniature one-way valve may be arranged in the passage to allow the cell 138 to receive fluid from outside the compliant tactile sensor 102.

Other examples of compliant tactile sensors that may be used in tactile systems described herein can be found in, for example, U.S. Pat. No. 11,867,574 (Fishel et al., “Fluidic Tactile Sensor”, 2024) and U.S. Pat. No. 9,080,918 (Fishel et al., “Compliant Tactile Sensor with Fluid-Filled, Sponge-Like Material”, 2015).

### EXAMPLE III

### Compliant Sensor Contact

FIG. 2 illustrates an example compliant sensor contact 204 that may be used as a sensor contact in tactile sensing systems described herein. The illustrated compliant sensor contact 204 is a fluid-based device that is similar in construction to the compliant tactile sensor 102 (see Example II) with the exception of not including a pressure sensing circuit. In the illustrated example, the compliant sensor contact 204 is shaped for attachment to a proximal phalanx of a robotic finger or shaped for use with a compliant tactile sensor that is shaped for attachment to a distal phalanx of a robotic finger. In general, the compliant sensor contact 204 can be shaped for attachment to any desired surface of a robot and for arrangement in tandem with a compliant tactile sensor.

The compliant sensor contact 204 has a distal side 214, a proximal side 216 generally opposite to and spaced from the distal side 214, a ventral side 218, and a dorsal side 220 generally opposite to and spaced from the ventral side 218. The distal side 214, the proximal side 216, and the ventral side 218 have compliant portions that are deformable by applied contact force. The dorsal side 220 of the compliant sensor contact 204 may be attached to a surface of interest (e.g., surface 203a of a support structure 203). The surface of interest may be, for example, a surface of a robot part (e.g., a surface of a robotic finger).

The compliant sensor contact 204 includes a core 246, an elastic skin 248 disposed around a surface portion (246a-c) of the core 246, and a cell 252 occupying a space between the surface portion of the core 246 and the elastic skin 248. The cell 252 contains a fluid medium 262. In some examples, the fluid medium 262 can be an incompressible fluid (e.g., water) or a compressible fluid having a lower compressibility factor compared to the fluid medium used in a neighboring compliant tactile sensor so that the elastic skin 248 can preferentially deform towards the neighboring compliant tactile sensor.

The elastic skin 248 forms a compliant member of the compliant sensor contact 204 that is deformable in response to applied contact force. The elastic skin 248 can be formed from an elastomer (e.g., silicone) or other resilient material. In some examples, the material of the elastic skin 248 is substantially impermeable to the fluid medium 262 in the cell 252. In some examples, an outer surface 253 of the elastic skin 248 may include textures (not shown) to facilitate gripping of an external surface with the elastic skin 248.

The core 246 is relatively rigid compared to the elastic skin 248 (e.g., the elastic skin 248 can be pushed against the core 246 without deforming the core 246). In some examples, the core 246 may be constructed (e.g., machined or molded) from hard plastic or metal. The elastic skin 248 can be attached to the core 246 to encapsulate the cell 252 between the elastic skin 248 and the core 246. For example, the elastic skin 248 may be molded into the core 246 or may be formed separately and attached to the core 246. In some examples, the elastic skin 248 can be attached to the core 246 by retaining an edge portion 248d of the elastic skin 248 in an annular groove 258 formed in a dorsal portion 246d of the core 246 (the dorsal portion 246d is part of the dorsal side 220 of the compliant sensor contact).

In some examples, the surface 203a of the support structure 203 can play a role in assembly of the compliant sensor contact 204. For example, the surface 203a can extend over the dorsal portion 246d of the core 246 and the edge portion 248d of the elastic skin 248 and can be attached to the core 246 using, for example, threaded fasteners 255 that extend through holes 257 in the support structure 203 on which the surface 203a is located and threadedly engage corresponding holes 259 in the core 246. The force applied to the edge portion 248d by the surface 203a by forming the threaded connections may enable the edge portion 248d to form a gasket that seals the interface between the elastic skin 248 and the core 246 at the annular groove 258. In other examples, alternative methods of sealing the interface between the elastic skin 248 and the core 242 may be used (e.g., sealing with O-rings or diaphragms).

The elastic skin 248 has a distal portion 248a corresponding to the distal side 214 of the compliant sensor contact 204, a proximal portion 248b corresponding to the proximal side 216 of the compliant sensor contact 204, and a ventral portion 248c corresponding to the ventral side 218 of the compliant sensor contact 204. The core 246 has a distal surface 246a in opposing relation to and spaced from the distal portion 248a of the elastic skin 248 (a portion of the cell 252 is formed in this space). The core 246 has a ventral surface 246c in opposing relation to and spaced from the ventral portion 248c of the elastic skin 248 (a portion of the cell 252 is formed in this space). The core 246 has a proximal surface 246b disposed adjacent to the proximal portion 248b of the elastic skin 248.

In some examples, the proximal surface 246b of the core 246 engages the proximal portion 248b of the elastic skin 248, which may serve to discourage fluid in the cell 252 from moving proximally when a contact force is applied to the elastic skin 248. In some examples, the proximal portion 248b of the elastic skin 248 may engage a rigid wall 249 at the proximal side 216 of the compliant sensor contact 204 to reduce unwanted deformation of the elastic skin 248 at the proximal side. The rigid wall 249 may be attached to the support structure 203.

When a contact force is applied to the elastic skin 248 at any of the distal, proximal, and ventral portions 248a-c (e.g., by touching or colliding with the portions), the elastic skin 248 deforms, causing a change in fluid pressure inside the cell 252. When a contact force is applied to the elastic skin 248 at the ventral portion 248c and proximal portion 248b (e.g., the part of the proximal portion 248b elastic skin 248 that is not engaged with the proximal surface 246b of the core 246), the fluid in the cell 252 moves distally, applying a distally directed force to the distal portion 248a of the elastic skin 248. The compliant sensor contact 204 can be placed adjacent to a compliant tactile sensor (e.g., the compliant tactile sensor 102 in Example II) such that the distal deformation of the distal portion 248a of the elastic skin 248 applies a force to a compliant part of the compliant tactile sensor that can be detected and measured by the compliant tactile sensor (see Example IV). The elastic skin 248 can be made thinner in the distal portion 248a (e.g., the distal portion 248 can be thinner than the proximal portion 248b and the ventral portion 248c) to encourage deformation of the distal portion 248a when a contact force is applied to the elastic skin 248.

In some examples, the core 246 may be provided with an inflation port (not shown) that allows the cell 252 to be refillable with the fluid medium 262. The inflation port may be a passage formed in the core 246 and connected to the cell 252. The passage may be accessible from outside the compliant sensor contact 204 (e.g., have an opening at the dorsal side 246d of the core 246). In some examples, a miniature one-way valve may be arranged in the passage to allow the cell 252 to receive fluid from outside the compliant sensor contact 204.

### EXAMPLE IV

### Tactile Sensing System with Compliant Sensor Contact

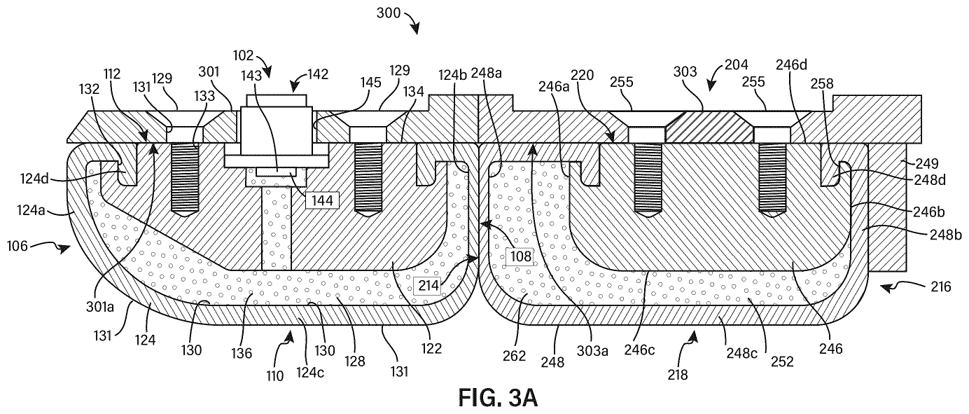

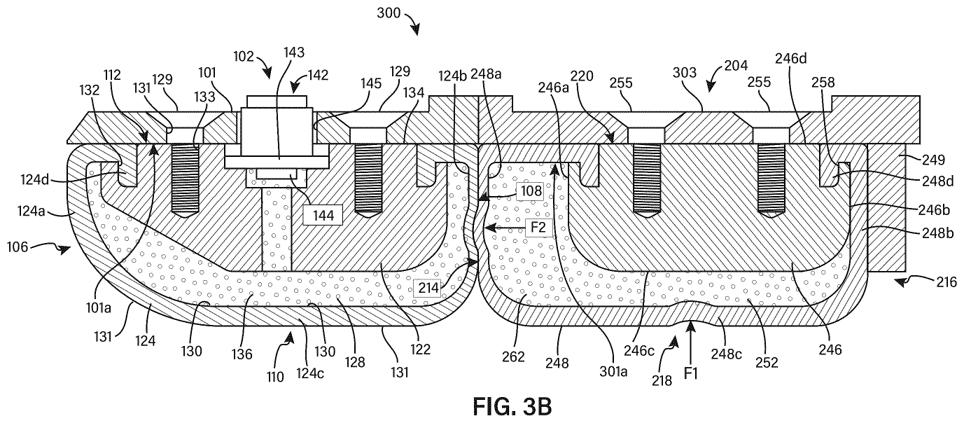

FIG. 3A illustrates a tactile sensing system 300 that can be used to enable tactile sensing on any surface of interest (e.g., robot surfaces). The tactile sensing system 300 includes a compliant tactile sensor (e.g., the compliant tactile sensor 102 in Example II) and a sensor contact (e.g., the compliant sensor contact 204 in Example III).

In the illustrated example, the compliant tactile sensor 102 is fastened to a surface 301a of a support structure 301, which may be a part of a robot or a structure to be attached to a part of a robot. The compliant sensor contact 204 is fastened to a surface 303a of a support structure 303, which may be part of a robot or a structure to be attached to a robot part. For example, the support structure 301 can be a distal phalanx (or a portion of a distal phalanx) of a robotic finger, and the support structure 303 can be proximal phalanx (or a portion of a proximal phalanx) of the robotic finger. The surfaces 301a, 303a are adjacent to each other such that the compliant sensor contact 204 is adjacent to the compliant tactile sensor 102.

The compliant tactile sensor 102 and the compliant sensor contact 204 are arranged such that the distal portion 248a of the elastic skin 248 of the compliant sensor contact 204 is adjacent to (e.g., abuts) the proximal portion 124b of the elastic skin 124 of the compliant tactile sensor 102. When a contact force is applied to the elastic skin 248 (see, e.g., contact force F1 acting on the ventral portion 248c of the elastic skin 248 in FIG. 3B), the elastic skin 248 deforms, causing a change in fluid pressure inside the cell 252 that applies a force to the distal portion 248a of the elastic skin 248 (see, e.g., force F2 acting on the distal portion 248a in FIG. 3B). The pressure acting on the distal portion 248a of the elastic skin 248 is transmitted to the adjacent proximal portion 124b of the elastic skin 124, causing deformation of the elastic skin 124 and a change in the fluid pressure inside the cell 128 of the compliant tactile sensor 102 that is measurable by the pressure sensing circuit 142.

### EXAMPLE V

### Tactile Sensing System with Rocker Sensor Contact

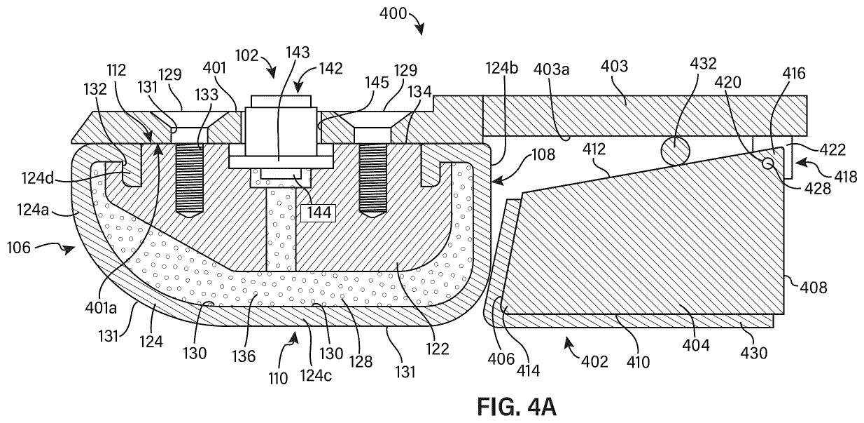

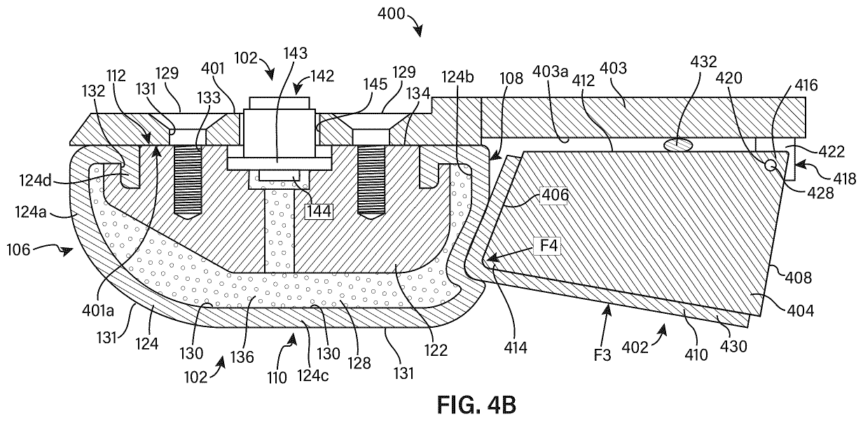

FIG. 4A illustrates a tactile sensing system 400 that can be used to enable tactile sensing on any surface of interest (e.g., robot surfaces). The tactile sensing system 400 includes a compliant tactile sensor (e.g., the compliant tactile sensor 102 in Example II) and a sensor contact (e.g., a rocker sensor contact 402).

In the illustrated example, the compliant tactile sensor 102 is fastened to a surface 401a of a support structure 401, which may be a part of a robot or a structure to be attached to a part of a robot. The rocker sensor contact 402 is rotatably coupled to a surface 403a of a support structure 403, which may be part of a robot or a structure to be attached to robot part. For example, the support structure 401 can be a distal phalanx (or a portion of a distal phalanx) of a robotic finger, and the support structure 403 can be proximal phalanx (or a portion of a proximal phalanx) of the robotic finger. The surfaces 401a, 403a are adjacent to each other such that the rocker sensor contact 402 is adjacent to the compliant tactile sensor 102.

The rocker sensor contact 402 includes a rocker body 404 having a distal side 406, a proximal side 408 generally opposite to and spaced from the distal side 406, a ventral side 410, and a dorsal side 412 generally opposite to and spaced from the ventral side 410. The rocker body 404 has a tip region 414 formed in an area between the distal side and the ventral side. The rocker body 404 has a fulcrum region 416 formed in an area between the proximal side 408 and the dorsal side 412. The rocker body 404 may have a polygonal shape (e.g., an irregular trapezoidal shape as illustrated). The tip region 414 and the fulcrum region 416 may be spaced apart generally along a diagonal of the polygonal shape.

In a neutral position (e.g., when a contact force is not applied to the rocker sensor contact 402), the tip region 414 is the closest part of the rocker body 404 to the elastic skin 124 of the compliant tactile sensor 102 and is in opposing relation to the proximal portion 124b of the elastic skin 124 (or to the proximal side 108 of the compliant tactile sensor 102). In the neutral position, the tip region 414 may contact but not exert a force on the proximal portion 124b of the elastic skin 124 of the compliant tactile sensor 102 or may be separated from the proximal portion 124b by a gap. The gap, if present, is small enough such that when the rocker body 404 is rotated (or pivoted) towards the compliant tactile sensor 102, the tip region 414 can engage the proximal portion 124b of the elastic skin 124.

In some examples, one or more surfaces of the rocker body 404 may be covered with compliant material. For example, a compliant covering 430 (which may be made of the same material as the elastic skin 124 or a different type of resilient material) may be attached to a surface of the rocker body 404 at the ventral side 410. In some examples, the compliant 430 may extend over a surface of the tip region 414 and may be attached to a surface of the rocker body 404 at the distal side 406. The compliant covering 430 may function as an energy absorber for a robot surface to which the rocker sensor contact 402 is attached. The portion of the compliant covering 430 extending over the surface of the tip region 414 and the surface of the distal side 406 may protect the elastic skin 124 from damage by the rocker body 404 (e.g., by allowing the elastic skin 124 to be engaged with similarly compliant material). In the neutral position, the portion of the compliant covering 430 extending over the surface of the tip region 414 may contact the elastic skin 124.

The rocker sensor contact 402 includes a rotational joint structure 418 that may be used to form a rotational joint (e.g., a pivot joint or a hinge joint) between the rocker body 404 and the surface 403a of the support structure 403. In some examples, the rotational joint structure 418 can include a pin 428 inserted in a hole 420 formed in the fulcrum region 416 of the rocker body 404. The rotational joint structure 418 can include a support mount 422 (e.g., a bracket) that supports the pin 428 (e.g., the support mount can include holes to receive the pin 428). In one example, the pin 428 can be rotationally fixed to the support mount 422 such that the rocker body 404 can rotate on the pin 428 about a rotational axis defined by the pin 428. The support mount 422 can include features to attach it to the support surface 403a of the support structure 403 (e.g., holes that can receive fasteners).

Other configurations of the rotational joint structure 418 are possible. For example, instead of rotationally fixing the pin 428 to the support mount 422, the pin may be rotationally fixed to the rocker body 404 and rotatably supported on support mount 422. In this example, the pin and rocker body 404 may rotate together relative to the support mount 422 about a rotational axis defined by the pin.

In some cases, the rotational joint structure 418 may include a stop member that limits rotation of the rocker body 404 in a direction away from the compliant tactile sensor 102. The stop member may help establish a neutral position of the rocker body 404 and also prevent the rocker body 404 from swinging out to a position in which the rocker body 404 cannot engage the elastic skin 124 of the compliant tactile sensor 102 when the rocker body 404 is acted upon by a contact force.

When a contact force is applied to the ventral side 410 of the rocker body 404 (see, e.g., contact force F3 acting on the ventral side 410 of the rocker body 404 in FIG. 4B on the ventral side 410), the rocker body 404 rotates like a lever towards the compliant tactile sensor 102 to engage and apply a force to the proximal portion 124b (see, e.g., force F4 acting on the proximal portion 124b in FIG. 4B). The force F4 applied to the proximal portion 124 of the elastic skin 124 is proportional to the force F3 applied to the ventral side 410. The force applied to the proximal portion 124b of the elastic skin 124 deforms the elastic skin 124, causing a change in fluid pressure inside the cell 128 of the compliant tactile sensor 102 that is measurable by the pressure sensing circuit 142 of the compliant tactile sensor 102.

When the contact force is released form the rocker body 404, the rocker body 404 can return to the neutral position. In some examples, the elastic skin 124 may provide a spring force to return the rocker body 404 to the neutral position. In other examples, the rocker sensor contact 402 may include a spring that biases the rocker body 404 to the neutral position. For example, a compression spring 432 may be arranged between the rocker body 404 and the surface 403a of the support structure 403 to return the rocker body 404 to the neutral position. Alternatively, the pin 428 in the rotational joint structure may be a spring-loaded pin. For example, the pin 428 may be provided with a torsional spring that can return the pin 428 to a neutral position when force is released from the rocker body 404.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A tactile sensing system comprises a compliant tactile sensor comprising a first compliant member and a sensing circuit arranged to detect and measure a response of the first compliant member to contact forces applied to the first compliant member; and a sensor contact disposed adjacent to the first compliant member and in a position to mechanically engage and apply a first contact force to the first compliant member in response to a second contact force applied to the sensor contact.

Example 2: The tactile sensing system according to Example 1, wherein the sensor contact comprises a second compliant member disposed adjacent to the first compliant member, wherein the second compliant member deformably engages the first compliant member in response to the second contact force applied to the sensor contact.

Example 3: The tactile sensing system according to Example 1, wherein the sensor contact comprises a rocker body that is rotatably supported relative to the first compliant member, wherein the rocker body rotates into engagement with the first compliant member in response to the second contact force applied to the sensor contact.

Example 4: The tactile sensing system according to Example 2, wherein the compliant tactile sensor comprises a first cell enclosed at least in part by the first compliant member and containing a first fluid medium, and wherein the sensing circuit is a pressure sensing circuit arranged to detect and measure fluid pressure inside the first cell.

Example 5: The tactile sensing system according to Example 4, wherein the sensor contact comprises a second cell enclosed at least in part by the second compliant member and containing a second fluid medium that is different from the first fluid medium, and wherein the second contact force produces a change in fluid pressure inside the second cell that is transmitted to the first cell through deformable contact between the second compliant member and the first compliant member.

Example 5a: The tactile sensing system according to Example 4, wherein the sensor contact comprises a second cell enclosed at least in part by the second compliant member and containing a second fluid medium that is different from the first fluid medium, and wherein the second contact force causes a change in fluid pressure inside the second cell that is transmitted to the first compliant member as the first contact force.

Example 6: A tactile sensor comprises a compliant tactile sensor comprising a first cell containing a first fluid medium, a first elastic skin forming at least a portion of a boundary of the first cell, and a pressure sensing circuit communicatively coupled to the first cell, wherein contact forces applied to the first elastic skin deform the elastic skin to produce measurable changes in fluid pressure inside the first cell; and a compliant sensor contact comprising a second cell containing a second fluid medium and a second elastic skin forming at least a portion of a boundary of the second cell, the second elastic skin having a distal portion disposed adjacent to a proximal portion of the first elastic skin, wherein a contact force applied to the second elastic skin produces a measurable change in fluid pressure inside the second cell that is transmitted to the first cell through deformable engagement between the distal portion of the second elastic skin and the proximal portion of the first elastic skin.

Example 7: A tactile sensing system according to Example 6, wherein the compliant tactile sensor further comprises a first core, wherein the first elastic skin is disposed around a first surface portion of the first core, and wherein the first cell is encapsulated between the first elastic skin and the first surface portion of the first core.

Example 8: A tactile sensing system according to Example 7, wherein the first core comprises a channel connected to the first cell, and wherein the pressure sensing circuit comprises a pressure transducer exposed to the fluid pressure in the first cell through the channel.

Example 9: A tactile sensing system according to Example 8, wherein the first core comprises a chamber connected to the channel, and wherein the pressure transducer is mounted at least partially within the chamber.

Example 10: A tactile sensing system according to any one of Examples 7-9, wherein the compliant sensor contact further comprises a second core, wherein the second elastic skin is disposed around a second surface portion of the second core, and wherein the second cell is encapsulated between the second elastic skin and the second surface portion of the second core.

Example 11: A tactile sensing system according to Example 10, wherein the second core comprises a distal surface in opposing relation to the distal portion of the second elastic skin, and wherein a portion of the second cell is formed in a space between the distal surface of the second core and the distal portion of the second elastic skin.

Example 12: A tactile sensing system according to Example 11, wherein the second core comprises a proximal surface opposite to and spaced from the distal surface of the second core, wherein the second elastic skin comprises a proximal portion opposite to and spaced from the distal portion of the second elastic skin, and wherein the proximal surface of the second core engages the proximal portion of the second elastic skin.

Example 13: A tactile sensing system according to Example 11, wherein the second core comprises a proximal surface opposite to and spaced from the distal surface of the second core, wherein the second elastic skin comprises a proximal portion opposite to and spaced from the distal portion of the second elastic skin, and wherein the proximal portion of the second elastic skin is rigidly supported.

Example 14: A tactile sensing system according to any one of Examples 6-13, wherein the first fluid medium and the second fluid medium are different.

Example 15: A tactile sensing system according to Example 14, wherein the first fluid medium is a compressible fluid, and wherein the second fluid medium is less compressible compared to the first fluid medium.

Example 16: A tactile sensing system according to Example 15, wherein the compressible fluid is air.

Example 17: A tactile sensing system according to any one of Examples 1-16, further comprising a first robot surface and a second robot surface disposed adjacent to the first robot surface, wherein the compliant tactile sensor is attached to the first robot surface, and wherein the compliant sensor contact is attached to the second robot surface.

Example 18: A tactile sensing system according to Example 17, wherein the first and second robot surfaces are surfaces of a robotic digit.

Example 19: A tactile sensing system comprises a compliant tactile sensor comprising a cell containing a fluid medium, an elastic skin forming at least a portion of a boundary of the cell, and a pressure sensing circuit communicatively coupled to the cell, wherein contact forces applied to the elastic skin deform the elastic skin to produce measurable changes in fluid pressure inside the cell; and a rocker sensor contact comprising a rocker body disposed adjacent to and rotatably mounted relative to the compliant tactile sensor, wherein a contact force applied to the rocker body causes the rocker body to rotate into engagement with the elastic skin and transmit the contact force to the elastic skin.

Example 20: A tactile sensing system according to Example 19, wherein the rocker body comprises a distal side, a proximal side in opposed spaced relation to the distal side, a ventral side, and a dorsal side in opposed spaced relation to the ventral side, wherein the rocker body includes a tip region at an intersection area between the distal side and the ventral side, and wherein the rocker body engages the elastic skin at the tip region and the distal side in response to applying the contact force to the ventral side or the proximal side.

Example 21: A tactile sensing system according to Example 20, wherein the rocker body includes a fulcrum region at an intersection area between the proximal side and the dorsal side, and wherein the tip and fulcrum regions and disposed along a diagonal of the rocker body.

Example 22: A tactile sensing system according to Example 21, further comprising a compliant covering disposed on at least a surface of the ventral side.

Example 23: A tactile sensing system according to Example 22, wherein the complaint covering is further disposed on a surface of the distal side.

Example 24: A tactile sensing system according to Example 22, wherein the compliant covering is further disposed on a surface of the tip region.

Example 25: A tactile sensing system according to Example 21, rocker sensor contact further comprises a rotational joint structure coupled to the fulcrum region.

Example 26: A tactile sensing system according to Example 25, further comprising a first robot surface and a second robot surface disposed adjacent to the first robot surface, wherein the compliant tactile sensor is attached to the first robot surface, and wherein the rotational joint structure is coupled to the second robot surface to form a rotational joint between the rocker body and the second robot surface.

Example 26a: A tactile sensing system according to Example 25 or 26, wherein the rotational joint structure comprises a spring-loaded pin.

Example 27: A tactile sensing system according to Example 26, further comprising a spring member disposed between the dorsal side of the rocker body and the second robot surface, wherein the spring member returns the rocker body to a neutral position when the contact force applied to the rocker body is released.

Example 28: A tactile sensing system according to any one of Examples 19-27, wherein the compliant tactile sensor further comprises a core, wherein the elastic skin is disposed around a surface portion of the core, and wherein the cell is encapsulated between the elastic skin and the surface portion of the first core.

Example 29: A tactile sensing system according to Example 28, wherein the core comprises a channel connected to the cell, and wherein the pressure sensing circuit comprises a pressure transducer exposed to the fluid pressure in the cell through the channel.

Example 30: A tactile sensing system according to any one of Examples 19-29, wherein the fluid medium is a compressible fluid.

Example 31: A method of tactile sensing on a robot comprises attaching a compliant tactile sensor to a first surface of the robot; disposing a compliant sensor contact adjacent to the compliant tactile sensor such that a proximal portion of a first compliant member of the compliant tactile sensor abuts a distal portion of a second compliant member of the compliant sensor contact; and attaching the compliant sensor contact to a second surface of the robot disposed adjacent to the first surface of the robot.

Example 32: A method of tactile sensing on a robot comprises attaching a compliant tactile sensor to a first surface of the robot; disposing a rocker body adjacent to the compliant tactile sensor such that a tip region of the rocker body is in opposing relation to a proximal portion of a compliant member of the compliant tactile sensor; and forming a rotational joint between a fulcrum region of the rocker body and a second surface of the robot disposed adjacent to the first surface of the robot, wherein the fulcrum region is diagonally spaced from the tip region.

Example 33: A method of tactile sensing on a robot comprises, in response to a first contact force applied to a sensor contact, mechanically engaging and applying a second contact force, by the sensor contact, to a compliant member of a compliant tactile sensor disposed adjacent to the sensor contact; and measuring, by a sensing circuit of the compliant tactile sensor, a response of the compliant member to the second contact force.

Example 34: A method according to Example 33, wherein the second contact force causes a change in fluid pressure inside a cell enclosed at least in part by the compliant member, and wherein measuring, by the sensing circuit of the compliant tactile sensor, the response of the compliant member to the second contact force comprises measuring the fluid pressure inside the cell.

Example 35: A method according to Example 33, wherein mechanically engaging and applying the second contact force, by the sensor contact, to the first compliant member comprises causing a second compliant member of the sensor contact to deformably engage the first compliant member of the compliant tactile sensor in response to the first contact force.

1. A tactile sensing system comprising:
a compliant tactile sensor comprising a first compliant member and a sensing circuit arranged to detect and measure a response of the first compliant member to contact forces applied to the first compliant member; and
a sensor contact disposed adjacent to the first compliant member and in a position to mechanically engage and apply a first contact force to the first compliant member in response to a second contact force applied to the sensor contact.

2. The tactile sensing system of claim 1, wherein the sensor contact comprises a second compliant member disposed adjacent to the first compliant member, wherein the second compliant member deformably engages the first compliant member in response to the second contact force applied to the sensor contact.

3. The tactile sensing system of claim 2, wherein the compliant tactile sensor comprises a first cell enclosed at least in part by the first compliant member and containing a first fluid medium, and wherein the sensing circuit is a pressure sensing circuit arranged to detect and measure fluid pressure inside the first cell.

4. The tactile sensing system of claim 3, wherein the sensor contact comprises a second cell enclosed at least in part by the second compliant member and containing a second fluid medium that is different from the first fluid medium, and wherein the second contact force causes a change in fluid pressure inside the second cell that is transmitted to the first compliant member as the first contact force.

5. The tactile sensing system of claim 1, wherein the sensor contact comprises a rocker body that is rotatably supported relative to the first compliant member, wherein the rocker body rotates into engagement with the first compliant member in response to the second contact force applied to the sensor contact.

6. A method of tactile sensing on a robot, the method comprising:
in response to a first contact force applied to a sensor contact, mechanically engaging and applying a second contact force, by the sensor contact, to a first compliant member of a compliant tactile sensor disposed adjacent to the sensor contact; and
measuring, by a sensing circuit of the compliant tactile sensor, a response of the first compliant member to the second contact force.

7. The method of claim 6, wherein the second contact force causes a change in fluid pressure inside a cell enclosed at least in part by the first compliant member, and wherein measuring, by the sensing circuit of the compliant tactile sensor, the response of the first compliant member to the second contact force comprises measuring the fluid pressure inside the cell.

8. The method of claim 6, wherein mechanically engaging and applying the second contact force, by the sensor contact, to the first compliant member comprises causing a second compliant member of the sensor contact to deformably engage the first compliant member of the compliant tactile sensor in response to the first contact force.

9. A tactile sensing system comprising:
a compliant tactile sensor comprising a first cell containing a first fluid medium, a first elastic skin forming at least a portion of a boundary of the first cell, and a pressure sensing circuit communicatively coupled to the first cell, wherein contact forces applied to the first elastic skin deform the elastic skin to produce measurable changes in fluid pressure inside the first cell; and
a compliant sensor contact comprising a second cell containing a second fluid medium and a second elastic skin forming at least a portion of a boundary of the second cell, the second elastic skin having a distal portion disposed adjacent to a proximal portion of the first elastic skin, wherein a contact force applied to the second elastic skin produces a measurable change in fluid pressure inside the second cell that is transmitted to the first cell through deformable engagement between the distal portion of the second elastic skin and the proximal portion of the first elastic skin.

10. The tactile sensing system of claim 9, wherein the compliant tactile sensor further comprises a first core, wherein the first elastic skin is disposed around a first surface portion of the first core, and wherein the first cell is encapsulated between the first elastic skin and the first surface portion of the first core.

11. The tactile sensing system of claim 10, wherein the first core comprises a channel connected to the first cell, and wherein the pressure sensing circuit comprises a pressure transducer exposed to the fluid pressure in the first cell through the channel.

12. The tactile sensing system of claim 11, wherein the first core comprises a chamber connected to the channel, and wherein the pressure transducer is mounted at least partially within the chamber.

13. The tactile sensing system of claim 10, wherein the compliant sensor contact further comprises a second core, wherein the second elastic skin is disposed around a second surface portion of the second core, and wherein the second cell is encapsulated between the second elastic skin and the second surface portion of the second core.

14. The tactile sensing system of claim 13, wherein the second core comprises a distal surface in opposing relation to the distal portion of the second elastic skin, and wherein a portion of the second cell is formed in a space between the distal surface of the second core and the distal portion of the second elastic skin.

15. The tactile sensing system of claim 14, wherein the second core comprises a proximal surface opposite to and spaced from the distal surface of the second core, wherein the second elastic skin comprises a proximal portion opposite to and spaced from the distal portion of the second elastic skin, and wherein the proximal surface of the second core engages the proximal portion of the second elastic skin.

16. The tactile sensing system of claim 14, wherein the second core comprises a proximal surface opposite to and spaced from the distal surface of the second core, wherein the second elastic skin comprises a proximal portion opposite to and spaced from the distal portion of the second elastic skin, and wherein the proximal portion of the second elastic skin is rigidly supported.

17. The tactile sensing system of claim 9, wherein the first fluid medium and the second fluid medium are different.

18. The tactile sensing system of claim 17, wherein the first fluid medium is a compressible fluid, and wherein the second fluid medium is less compressible compared to the first fluid medium.

19. The tactile sensing system of claim 9, further comprising a first robot surface and a second robot surface disposed adjacent to the first robot surface, wherein the compliant tactile sensor is attached to the first robot surface, and wherein the compliant sensor contact is attached to the second robot surface.

20. The tactile sensing system of claim 19, wherein the first and second robot surfaces are surfaces of a robotic digit.
